(19) United States
(12) Patent Application Publication
(10) Pub. No.: US 2017/0236173 A1
(43) Pub. Date: Aug. 17, 2017

(54) Method and device for real estate mobile and computer application providing real time live GPS location mapping, real estate agent search and real estate services

(71) Applicant: Penn Mason, Nashville, TN (US)

(72) Inventor: Penn Mason, Nashville, TN (US)

(21) Appl. No.: 15/045,473

(22) Filed: Feb. 17, 2016

(51) Int. Cl. G06Q 30/06; H04L 12/58; G06Q 50/00; G06F 17/30; G06Q 50/16

(52) U.S. Cl. CPC G06Q 30/0603; G06F 17/30424; G06F 17/30061; G06Q 50/16; G06Q 30/0641; G06Q 30/0617; G06Q 50/01; H04L 51/32

(57) ABSTRACT

Disclosed herein is a method to facilitate a user, interested in buying and selling of a real estate, with a catalogue of personals enlisted as real estate agents using a communication device interconnected over a social computing based environment. The method provides through a social computing based means. The means, wherein the user creates a user account and the user account enables the user to access the social computing based means; the social computing based means provides information associated with the user, facilitate communicate and interaction with other users having account associated with the social computing based means. Furthermore the method through the social computing based means provides a means to the user to post at least one information item over the social computing based means, view at least one information item posted by other users and web feeds.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The disclosure generally relates to the field of computerized management of real estate and, more specifically, the present invention relates to an electronic user device, and in particular, to a user device that finds services and allows purchases by the user of the device.

(2) Background

The real estate market is characterized by numerous inefficiencies that create problems for consumers, agents, and vendors. Consumers suffer from a lack of real estate information and tools. Although many real estate brokerages provide visibility into property listing information on their web sites, these tools remain surprisingly poor. Overall, brokerages and other online real estate companies have introduced online technology that perpetuates the agent's role as an information source, rather than embracing the reality that the agent's role is shifting to that of information interpreter, with a value proposition more oriented around experience, knowledge, and wisdom.

Residential real estate agents also suffer from numerous problems at present. First among these is competition for consumers. High commissions and low barriers to entry have caused the agent ranks to grow far more quickly than transaction volume, intensifying competition. Second, agents have a very difficult time marketing themselves. Brokerages typically do not promote one agent over another and thus expect agents to market themselves individually. This is costly and inefficient. Lastly, agents suffer from a lack of collaborative tools.

To stay competitive, agents increasingly turn to third-party lead sources. Several companies have met this demand by capturing customer information online and reselling it as “leads” to interested agents. Agents encounter several problems during this process. First, the leads may be very poorly qualified. Depending on how the lead seller induces customers to provide their contact information, the “leads” may comprise people that simply are curious to know the value of their house, for example. Second, the agent must expend significant time and effort to move the leads through a sales process. Third, leads purchasing is generally costly.

Vendors, or real estate service providers, can include mortgage lenders, appraisers, inspectors, title companies, escrow companies, insurers, contractors, moving companies, and other providers whose services relate to property transactions. Because each of their services is typically demanded in a property transaction, these vendors derive considerable business from informal professional networks. At present there is no mechanism that allows consumers to evaluate the value of a given network or to perceive it as an entity that has intrinsic value. It is very difficult, for instance, for an agent to market his or her “team” of linked professionals, and to derive additional business from the strength of the team.

Currently the in the market today home buyers use home search sites like Zillow, Trulia, Red fin etc. to start their journey to find homes. Only to find much of the information is incorrect and many of the homes are not available. They find something they want to look at or find out more information about, and then they contact an agent they may pop up on that search page hoping to get a call back. Many of these agents are not ready with the necessary information expected by a buyer. On top of that the home buyer often finds out when they do connect with an agent that the home they are really interested in is already under contract. This creates the first touch with the agent a negative one.

Therefor what is needed is a tool that generate leads for both the person looking to buy or sell a property and an agent that facilitates, so that both the parties can do their own leg works beforehand or a person looking to sell or buy a property can find the closest or the most convenient real estate agent to avail the service in the area of interest.

### BRIEF SUMMARY OF THE INVENTION

The primary objective of the present invention is to provide a method to facilitate a user, interested in buying and selling of a real estate, with a catalogue of personals enlisted as real estate agents using a communication device interconnected over a social computing based environment.

Further according to the invention the method provides a social computing based means. The means, wherein the user creates a user account and the user account enables the user to access the social computing based means; the social computing based means provides information associated with the user, facilitate communication and interaction with other users having account associated with the social computing based means. Furthermore the method through the social computing based means provides a means to the user to post at least one information item over the social computing based means, view at least one information item posted by other users and web feeds.

Moreover a graphical user interface provided in the present invention is operable to send and receive information associated with the users, operable to provide a user with a catalogue of personals enlisted as real estate agents. The catalogue provided via the graphical user interface is curated based on the location of the agent and the geographical distance of the agent from the user requesting the information and is represented over the graphical user interface with an interactive map identifying at least one of the agent and the user and the respective location.

Under an embodiment of the invention, a web based system that maintains a real estate web page. The web page having an aerial image map of a geographic region that can be navigated by a user. The web site system facilitates online collaboration for real estate transactions. When the user registers, the system creates an account for his real estate information. The account can include various folders for storing information about properties in which the user is interested. The user can also specify a real estate agent and/or other real estate service providers who should be permitted access to the user's account.

The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE DRAWINGS

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1. Illustrates a perspective view of the login screen of the invention.

FIG. 2. Illustrates a perspective view of the user interface with various filters of searching real estate personals in the invention.

FIG. 3. illustrates a perspective view of the user interface with interactive map locating various users in the invention.

FIG. 4. illustrates a perspective view of a user profile in the invention.

FIG. 5. illustrates a perspective view of a user profile with various options in the invention.

### DETAILED DESCRIPTIONS OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. Pat. No. 643,256 (“Movable touch pad with added functionality”, filed Ser. No. 10/643,256), touch screens such as those described in(but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006, keyboards, such as those mentioned in(but not limited to) U.S. patent application Ser. No. 07/711,760 (“Ergonomic keyboard input device”, filed on Jun. 6, 1991), mouse, such as those described in (but not limited to) (1) application Ser. No. 09/167,314 (“Computer mouse with enhance control button(s)”, filed on Oct. 6, 1998); (2) application Ser. No. 08/288,945 (“Roller mouse for implementing scrolling in windows applications”, filed on Aug. 10, 1994) and gesture recognition means, such as those described in(but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21,2012).

Display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices.

Connectivity of these devices with networks, such as the internet, an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document.

The present invention maybe implemented on applications that run on a single or variety of operating system platforms, including but not limited to OS X, WINDOWS, UNIX, IOS, ANDROID, SYMBIAN, LINUX, or embedded operating systems, such as VxWorks.

The present invention may also be implemented to work with various web browsers, including but not limited to Internet Explorer, Mozilla Firefox, Safari, and Opera, that access and handle various types of web pages constructed with various mark-up languages, such as HTML, HTML-5, XHTML, XML, etc. and the associated CSS (cascading style sheet) files and java-script files.

In a preferred embodiment of the invention the method to facilitate a user, interested in buying and selling of a real estate, with a catalogue of personals enlisted as real estate agents using a communication device interconnected over a social computing based environment is an application software or website. The said user is enabled to post at least one information item related to real estate over said social computing environment that can be viewed by another user associated with the environment.

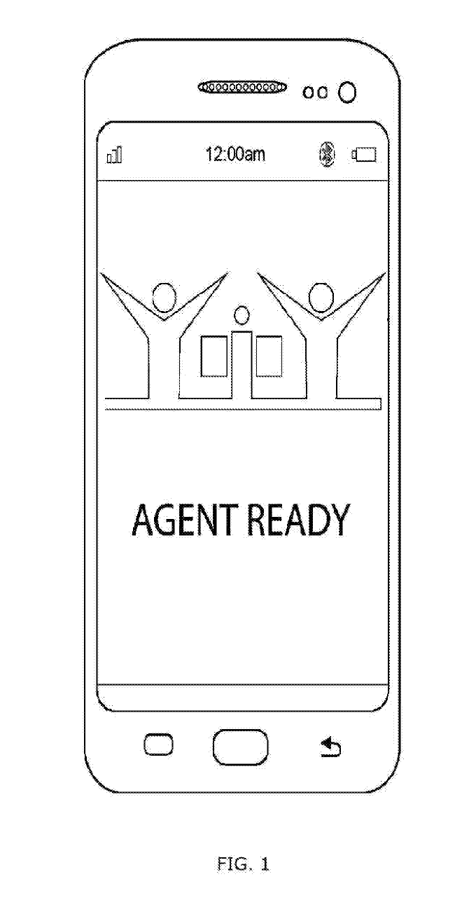

As shown in FIG. 1, a buyer or seller sign up and add a profile which includes if they are buying or selling. Based on the options they choose they would then enter basic information.

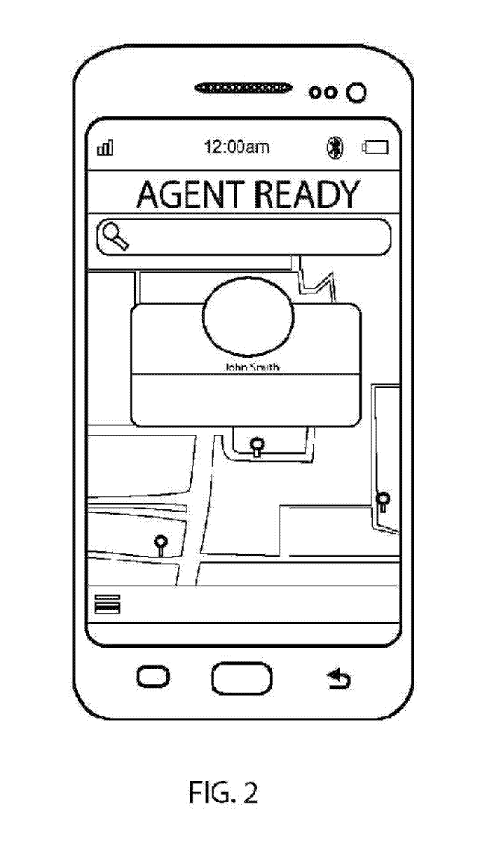

As shown in FIG. 2, the user will have a few options under their profile settings page to choose what type of real estate services they will be looking for. For example the user looking to buy or sell a home will simply have a home buyer or home seller option in the settings or their profile. The buyers' options will allow the user to set up within their profile many buyer options. Their Price Ranges, Areas of interest. Via ZIP CODES & Town Names, Type of home (brick, stone, siding) the buyer can simply save all their settings in their user profile. These options are optional but will be suggested to the user fill out as much of their profile as possible so that the application can provide the best experience for the user.

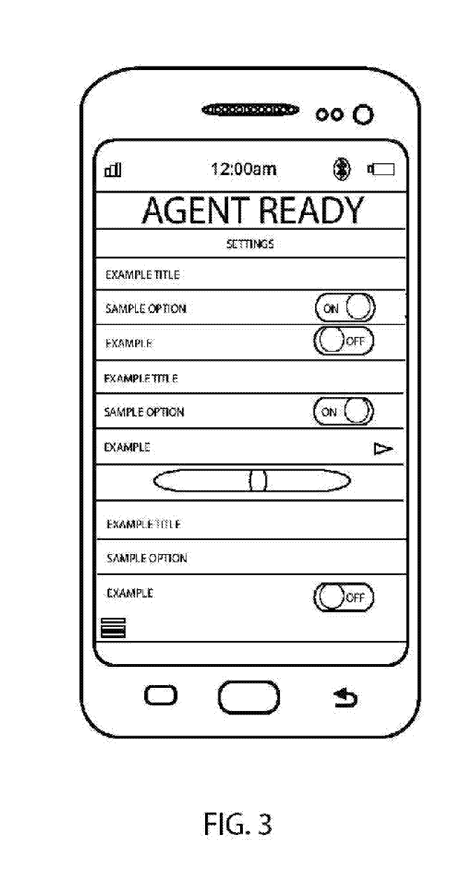

As shown in FIG. 3, the user taps on GPS search via location or zip code. The User then can see the GPS location mapping of agents nearest to them that is logged into the app and ready. Then the user taps on an agent via by map or list of agents nearest to him. Then the buyer or seller can search for a local licensed real estate agent by pulling up the map. There the consumer will see the agents nearest to them and contact the agent via call now or simply messaging them. The invention is a computer implemented application that allows the home buyer or seller to connect to a licensed real estate agent live in real time via GPS location search or via Zip Code location search. It connects the home buyer or seller to a real estate agent in their mapping area instantly in real time via Call Button or Text Messaging. The user does this simple search in their area and can see all the agents that are ready now via the GPS mapping tool or a list of agents closest to them based on their GPS location to help with their real estate needs. The list option shows the agents closest first to their search criteria which can be set in the GPS search settings of distance from 5 miles to a 50 mile from their GPS location. The GPS mapping tool is the main staple of the application. This live map shows all of the real estate licensed professionals live using the application right on the map closest to the user. Or shows the user what agents are live and ready via a zip code or address search in that area of interest. This is a new way to connect home buyer and home sellers with a licensed real estate professional. This allows the buyers and sellers to stop blindly searching for homes on the market. This application the application will potentially connect not only realtors and their clients but also clients in need of mortgage loans, builders, remodeling, home inspectors and much more. The future of the real estate lead application is not limited.

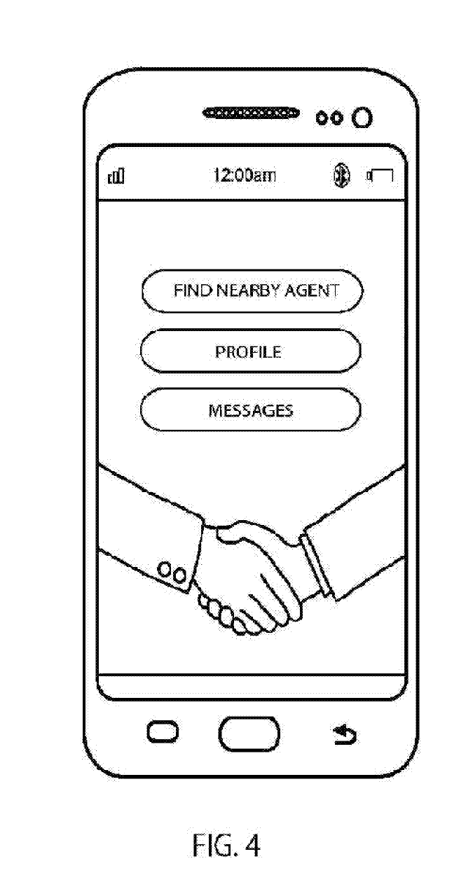

FIG. 4 depicts the user then has an option to call live or message the agent. The agent and the user now are connected.

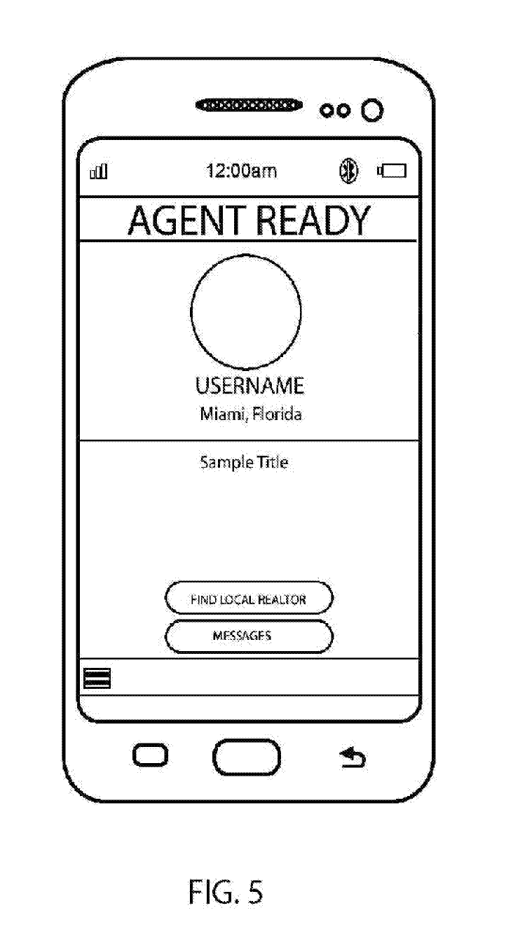

In a similar manner FIG. 5 depicts the users can save the agent information once connected. Agent has to approve the request. Agents will also be able to save potential clients the same way once the agent and client have approved.

Once a relationship is approved the user can talk freely with the agent via text or call button as shown in FIG. 6.

However, a user enlisted as an agent cannot freely contact users that are live and searching for agents. They will not see buyers or sellers on the map. An agent Yes Although the Agent Ready application will use current Text and Call methods, but the GPS search location technology to connect the user with the real estate agent in real time is new and not currently on the market.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed:

1. A method to facilitate a user, interested in buying and selling of a real estate, with a catalogue of personals enlisted as real estate agents using a communication device interconnected over a social computing based environment, method comprising:
providing through a social computing based means, a means to said user to create a user account, wherein said user account enables said user to access said social computing based means;
providing through said social computing based means, a means to said user to provide information associated with said user, communicate and interact with other users having account associated with said social computing based means;
providing through said social computing based means, a means to said user to post at least one information item over said social computing based means;
providing through said social computing based means, a means to said user to view at least one information item posted by other users over said social computing based means;
providing through said social computing based means, a means to said user to view web feeds;
providing a graphical user interface that is operable to send and receive information associated with said users;
receiving, via said graphical user interface operating on said device, a catalogue of personals enlisted as real estate agents, wherein said catalogue is curated based on the geographical distance of said agent from said user;
receiving, via said graphical user interface operating on said device, a location of an agent;
providing, via said graphical user interface operating on said computing device, a representation of at least one of said agent and said user and the respective location thereof.

2. The method to facilitate a user with a catalogue of personals enlisted as real estate agents as set forth in claim 1, wherein said social computing based means comprise an application software.

3. The method to facilitate a user with a catalogue of personals enlisted as real estate agents as set forth in claim 1, wherein said social computing based means comprise a website.

4. The method to facilitate a user with a catalogue of personals enlisted as real estate agents as set forth in claim 1, wherein said information item is an information related to real estate.

5. The method to facilitate a user with a catalogue of personals enlisted as real estate agents as set forth in claim 1, wherein said web feed comprise said at least one information item.

6. The method to facilitate a user with a catalogue of personals enlisted as real estate agents as set forth in claim 1, wherein said representation includes a map identifying where said at least one of said user and agent is located.

7. The method to facilitate a user with a catalogue of personals enlisted as real estate agents as set forth in claim 1, wherein said information associated with said user identifies between buying or selling

8. The method to facilitate a user with a catalogue of personals enlisted as real estate agents as set forth in claim 1, wherein said method further comprise of a mean to search users enlisted in said social computing based environment as real estate agents in real time.

9. The method to facilitate a user with a catalogue of personals enlisted as real estate agents as set forth in claim 1, wherein said mean to search users enlisted as real estate agents comprises of geographical location of said real estate agents.

10. The method to facilitate a user with a catalogue of personals enlisted as real estate agents as set forth in claim 1, wherein said mean to search users enlisted as real estate agents comprises of ZIP code of said real estate agents.

11. The method to facilitate a user with a catalogue of personals enlisted as real estate agents as set forth in claim 1, wherein said means to said user to communicate and interact with other users having account associated with said social computing based means comprises of voice call.

12. The method to facilitate a user with a catalogue of personals enlisted as real estate agents as set forth in claim 1, wherein said means to said user to communicate and interact with other users having account associated with said social computing based means comprises of text message.
